(19) United States
(12) Patent Application Publication
(10) Pub. No.: US 2017/0017351 A1
(43) Pub. Date: Jan. 19, 2017

(54) SYSTEM AND METHOD FOR UPDATING NOTIFICATIONS ACROSS DEVICES AND APPLICATIONS

(71) Applicant: PCMS Holdings, Inc., Wilmington, DE (US)

(72) Inventor: Mona SINGH, Cary, NC (US)

(21) Appl. No.: 15/301,268

(22) PCT Filed: Mar. 9, 2015
(86) PCT No.: PCT/US2015/019516

§ 371 Date: Sep. 30, 2016

Related U.S. Application Data
(60) Provisional application No. 61/973,015, filed on Mar. 31, 2014.

(51) Int. Cl. G06F 3/0481; G06F 3/14; H04L 29/08; G06F 3/0484

(52) U.S. Cl. CPC G06F 3/0481; G06F 3/04847; G06F 3/14; H04L 67/22; H04L 67/26; G06F 3/04842

(57) ABSTRACT

Systems and methods are providing for handling notifications across multiple devices associated with a user. A notification, such as an alert, is sent by an application server to a plurality of user devices associated with a user. The notification may be sent as a push notification. When the user interacts with the notification on one of the associated user devices, the device sends a report to the application regarding the extent to which the user has interacted with the notification. In response to the report regarding the extent of user interaction, the application sends a message downgrading the notification on other devices associated with the user. The message may be downgraded on other devices only if the user has interacted with the notification on a device designated as a primary device.

### CROSS-REFERENCE TO RELATED APPLICATIONS

The present application is a non-provisional filing of, and claims benefit under 35 U.S.C. §119(e) from, U.S. Provisional Patent Application Ser. No. 61/973,015, filed Mar. 31, 2014, incorporated herein by reference in its entirety.

### FIELD

The present disclosure relates to user notifications provided on devices and in applications such as wearable computers, mobile phones, desktop computers, laptop computers, and vehicle-based computers.

### BACKGROUND

A growing number of devices make use of user notifications from applications. Support for notifications on devices is extremely useful in providing timely information to a user independent of the device the user happens to be currently using. However, the increasing number of devices to which notifications can be delivered leads to multiple unnecessary interactions on the user's part. Current notification systems can and do lead to situations where the user is presented with the same notification on multiple devices and applications running on those devices.

### BRIEF DESCRIPTION OF THE DRAWINGS

FIG. 1 illustrates an exemplary wireless transmit/receive unit (WTRU) that may be employed as a user device, application server, notification server and/or other network node in embodiments described herein.

FIG. 2 illustrates an exemplary network entity that may be employed as a user device, application server, notification server and/or other network node in embodiments described herein.

FIGS. 3A-C are schematic block diagrams illustrating communications between an application server and user devices in some embodiments.

FIG. 4 is a message sequence chart illustrating an exemplary high-level architecture employed in some embodiments.

FIG. 5 is a functional block diagram illustrating relationships between exemplary components of a user device and an application server in some embodiments.

FIG. 6 is a functional block diagram illustrating an exemplary architecture of an application server in some embodiments.

FIG. 7 is a flow chart illustrating a method of updating notifications in some embodiments.

### DETAILED DESCRIPTION

The present disclosure provides methods and systems wherein devices and applications communicate the user's level of engagement with each notification in such a way that the user needs to have only one interaction with any individual notification, leading to a better user experience. In one embodiment, a user may have to interact at most once with an individual notification, that is, avoid interacting altogether with a notification that is no longer valuable.

The present disclosure provides systems and method that permit users of wearable computers, smartphones, and desktop devices more easily to interact with notifications across various devices and applications. In particular, the present disclosure provides systems and methods that allow redundant notifications to be removed from all other devices and applications where it may have appeared so as to save the user the trouble of dealing with a notification on more than one device or dealing with the notification on more than one application on the same device.

Exemplary embodiments disclosed herein are implemented using one or more wired and/or wireless network node, such as a wireless transmit/receive unit (WTRU) or other network entity.

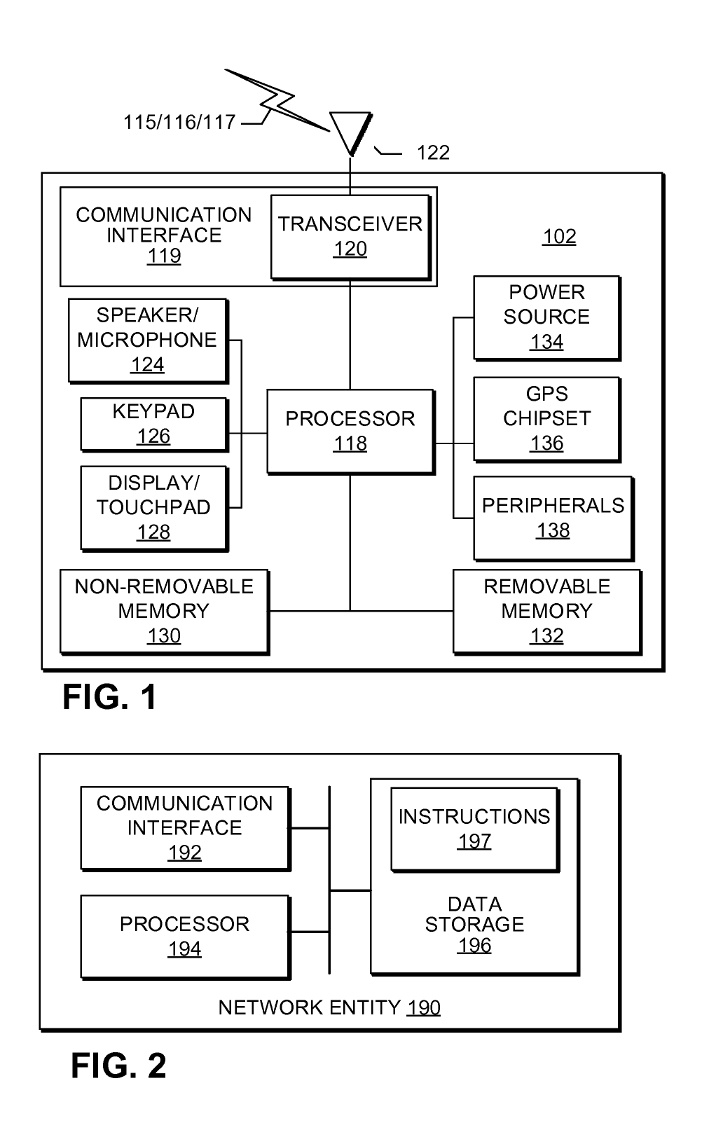

FIG. 1 is a system diagram of an exemplary WTRU 102, which may be employed as a user device in embodiments described herein. As shown in FIG. 1, the WTRU 102 may include a processor 118, a communication interface 119 including a transceiver 120, a transmit/receive element 122, a speaker/microphone 124, a keypad 126, a display/touchpad 128, a non-removable memory 130, a removable memory 132, a power source 134, a global positioning system (GPS) chipset 136, and sensors 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1 and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1 depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, as examples. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, as examples.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. As examples, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include sensors such as an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 2 depicts an exemplary network entity 190 that may be used in embodiments of the present disclosure, for example as an application server, notification server, or user device. As depicted in FIG. 2, network entity 190 includes a communication interface 192, a processor 194, and non-transitory data storage 196, all of which are communicatively linked by a bus, network, or other communication path 198.

Communication interface 192 may include one or more wired communication interfaces and/or one or more wireless-communication interfaces. With respect to wired communication, communication interface 192 may include one or more interfaces such as Ethernet interfaces, as an example. With respect to wireless communication, communication interface 192 may include components such as one or more antennae, one or more transceivers/chipsets designed and configured for one or more types of wireless (e.g., LTE) communication, and/or any other components deemed suitable by those of skill in the relevant art. And further with respect to wireless communication, communication interface 192 may be equipped at a scale and with a configuration appropriate for acting on the network side—as opposed to the client side—of wireless communications (e.g., LTE communications, Wi-Fi communications, and the like). Thus, communication interface 192 may include the appropriate equipment and circuitry (perhaps including multiple transceivers) for serving multiple mobile stations, UEs, or other access terminals in a coverage area.

Processor 194 may include one or more processors of any type deemed suitable by those of skill in the relevant art, some examples including a general-purpose microprocessor and a dedicated DSP.

Data storage 196 may take the form of any non-transitory computer-readable medium or combination of such media, some examples including flash memory, read-only memory (ROM), and random-access memory (RAM) to name but a few, as any one or more types of non-transitory data storage deemed suitable by those of skill in the relevant art could be used. As depicted in FIG. 1F, data storage 196 contains program instructions 197 executable by processor 194 for carrying out various combinations of the various network-entity functions described herein.

The exemplary systems and methods described herein are useful for managing notifications from social-networking services, email services, brokerage services, banking services, or other services that provide notifications, such as news, weather, or traffic notifications, or calendar services that provide reminders in the form of notifications. Types of notifications include alerts, banners, tile notifications, and badge notifications, among other examples.

The devices capable of being used in conjunction with the methods and systems described herein include desktop, laptop, and tablet computers, e-readers, personal digital assistants, smartphones, wearable computing devices such as electronic glasses (e.g. Google Glass) and watches, among other devices.

In an exemplary embodiment, a user with a smartphone has set up notifications for a first social networking application to appear as a banner and notifications for a second, different social networking application to appear as an alert. When the user receives a notification on the second social networking application, the second application presents an alert as a modal dialog on the smartphone. The user then dismisses the alert. According to an embodiment described herein, once the user interacts with this notification on the smartphone, the notification is removed from other devices associated with the user and the second social networking application itself so that the user does not have to interact with that notification again on a different device.

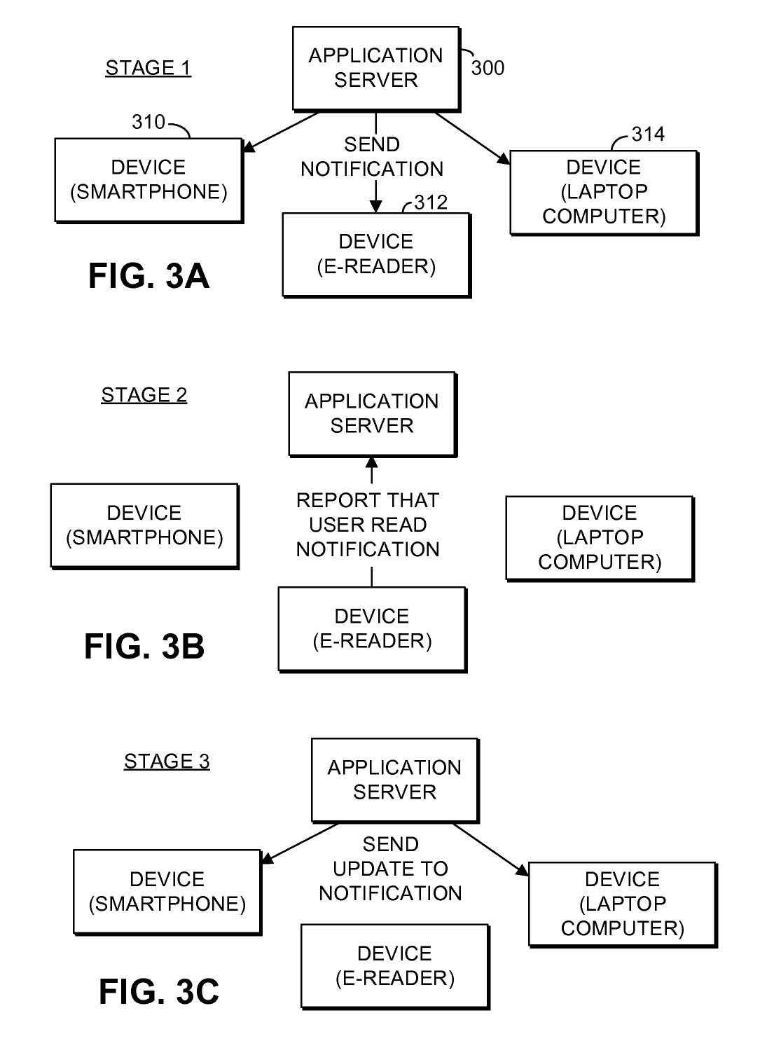

Exemplary communications between an application server and a plurality of user devices associated with a particular user are illustrated in FIGS. 3A-3C.

Stage 1 is illustrated in FIG. 3A. In FIG. 3A, an application server 300, such as a server of a social networking application, broadcasts a notification over a network to several devices associated with a user, such as a smartphone 310, an e-book reader 312, and a desktop computer 314. The notification may be a tile notification, a lock screen alert, a banner notification, a badge notification, a toast notification, or other notification type. As described in further detail below, the application server may not specify the notification type and may instead specify a notification weight, allowing the respective user devices to determine the type of notification to use for the notification weight. The notification may be a push notification.

In Stage 2, illustrated in FIG. 3B, the user interacts with the notification on one of the devices (e.g., the e-book reader). The e-book reader sends a report to the application server over the network indicating that the user has engaged with the notification, for example by dismissing the notification or by gazing at the notification. The report may indicate the type of interaction, the report may include an updated (e.g. lowered) notification weight, or the report may include a value indicating a level of engagement between the user and the notification.

As a result of the reported user interaction, in Stage 3, illustrated in FIG. 3C, the application broadcasts over the network, to the user's devices, a message downgrading the notification. In some embodiments, this message is also sent to the device on which the user engaged with the notification, while in other embodiments the message is not sent to that device.

The message downgrading the notification may include an instruction to cancel the notification. Alternatively, the message may include an instruction to change the notification type to a less prominent notification; for example the message may include an instruction to downgrade the notification from an alert to a banner. In some embodiments, as described in greater detail below, the message may include an updated (e.g., lowered) notification weight.

In another embodiment, a user employs a wearable computer such as Google Glass. The user's notification from LinkedIn shows up (for example, as an alert) in Glass. The present embodiment can prevent such notifications from subsequently being displayed on multiple devices. While the present embodiment is described with respect to Glass, it is to be understood that the embodiment is also applicable to other devices, such as smartphones and notification means such as holograms or other augmented reality formats.

In an exemplary method a notification arrives as an alert on Glass, but the user does not expand the alert to see its content. In this case, the system permits the same notification to appear on the user's other devices as if the user had not seen it on Glass. In another method, the user may look at an alert and expand the alert to see its content, but only for a short period of time, for example a period of time shorter than a threshold period. In such an instance, the system may assume that the notification has not been fully dealt with, and therefore the notification is not completely removed from other devices associated with the user or the application that triggered the alert. In contrast, if the user actively expands an alert and reads it on Glass, the system treats this as an indication that the user has dealt with the notification. In that case, the system removes the notification from the other devices associated with the user and the application that triggered the alert.

In another embodiment, a notification that appears as a banner on a smartphone remains visible as a notification on other devices, though in a subdued (partly read) state.

In another embodiment, each notification from a specified application is tied to a (configured) primary device wherein the user must interact with the notification on the primary device in order to dismiss the notification. Unless this is done, the notification remains active on all devices. The user may configure any device as the primary device. For example, the user may make a browser the primary “device” for LinkedIn and his smartphone the primary device for Facebook.

In another embodiment, the user may identify certain devices as secondary devices for notifications from a particular application. Viewing a notification from that application on the specified secondary device would not have any effect on the state of that notification. In one embodiment, wearable computers such as Glass and watches may be identified as secondary. Doing so would prevent a notification from being accidentally marked as viewed, which is a greater risk on a wearable device than on a smartphone or traditional computer.

In one embodiment, there is a centralized notification setup method for each application. The setup allows each device to be identified and the behavior to be defined. In such a system the user could set up notification viewing to not have an impact on certain devices. This would make it possible for a notification seen on a wearable device to remain in an unread state until the user sees the same notification on a device that was identified by the user as primary.

In another embodiment, the behavior of the notification depends on the app triggering the notification. For example, notifications from LinkedIn may be treated differently than notifications from Gmail.

In one embodiment the behavior of the notification depends on the notification style (for example, lock screen alert, banners, or pop up alerts). For example, we can require that the status of a notification that appears on a phone's lock screen remain unchanged even if the user may possibly have seen it.

In one embodiment the behavior of the notification depends on its type. For example, if the notification is for an important event (such as a message received in an application), the notification may remain active until the user interacts explicitly with it. But if the notification is for an unimportant event (like comments by other people on the user's comments), the notification need not remain active because users typically do not respond to such notifications. In another embodiment, the behavior of the notification depends on a combination of its type and the specific user's past interactions (or absence of interactions) with notifications of the same type.

This disclosure provides a method for notifications where the devices of a user communicate with an application or rather the notification manager of an application. The notification manager keeps track of the user's interactions with notifications on each device. Each interaction with the notification is interpreted by the notification manager and associated modules with respect to the device on which it occurs and the type of the notification. This information helps the notification manager determine which notification on which devices can be automatically dismissed, thereby saving the user the time and effort of dealing with avoidable interactions. The notification manager communicates with each registered device of a user to bring the device up to date with respect to each relevant notification, sending and revoking notifications to it.

In some embodiments, a user may have, on a single device, more than one local application capable of displaying notifications from a networked application, such as a network-based social networking application. For example, a device of the user, such as a smartphone, may include a local LinkedIn application as well as an email application capable of displaying email messages from the Linked-In network-based application. In such embodiments, the notification manager may operate not only to prevent a notification from being presented on multiple devices, but also to prevent notification from being presented by different local applications on the same device. For example, the notification manager may send a LinkedIn notification as an email to the user's email account and as an alert to the user's local LinkedIn application. If the notification manager receives a report indicating that the user has read the email notification on the smartphone, it then sends a message to the smartphone canceling the alert on the local LinkedIn application. If other devices and applications are also associated with the user's LinkedIn account, the notification manager may also send reports to those other devices and applications to cancel the notification on those other devices and applications.

A system according to some embodiments includes a Server Notification Manager and the Device Notification Manager. The Application Logic determines the contents of notifications. The Server Notification Manager provides the hooks by which the contents of a notification can be updated, including its relative priority and expiration conditions. The Server Notification Manager conveys the notification content (original and updated) to the Device Notification Manager.

The Device Notification Manager is part of the Device Operating System. It works based on the elements enumerated below to determine how to present the notification and determine how (including how completely) the user has interacted with the notification. The elements based on which the Device Notification Manager works include user configuration, user behavior (such as how long the user has gazed at a notification), and contextual elements. The contextual elements can include environmental conditions such as ambient brightness or noise, device orientation, and cross-application settings (e.g. a setting indicating that a brokerage application is more important than a social networking application such as Facebook).

In some embodiments each notification is assigned a respective notification weight. The notification weight may be determined in advance for that type of notification, for example by the application developer. Alternatively, the notification weight may be determined by the content of the notification. For example, the notification weight may be based on the length of the notification (in words, characters, bytes or otherwise). Alternatively, the notification weight may be based at least in part on a number of pictured included in the notification, on the duration of one or more videos embedded in the notification, or through other techniques. The notification weight may be generated based on a combination of the foregoing or other factors.

In some embodiments, each notification is provided with a respective notification priority level. The notification priority level may be set in advance for that type of notification by the application developer. As an alternative, an application may register a number of notification categories, and a user may set notification priority levels for different notification categories. For example, a trading application may register five notification categories, and the user may allocated a notification priority level to each of the notification categories. Each notification category may be assigned a default notification priority level until the notification priority level is changed by the user of the application.

TABLE 1

| Notification Category for Trading | Initial Notification | Notification |
|---|---|---|
| Application | Weight | Priority Level |
| Customer response available | 1000 | 1 |
| Order received | 1500 | 1 |
| Order expired | 2000 | 2 |
| Order executed | 2400 | 3 |
| Margin call | 5000 | 4 |

In some embodiments, each type of notification presentation (e.g. popup alert, alert counter on application icon, item in notification list, full banner, stub banner, alert counter within application, or toast notification, among others) is associated with a presentation type score. Different device types are associated with different sets of notification presentation types. For example, smartphones are typically capable of presenting different types of notifications than are personal computers or smart glasses.

TABLE 2

| Notification Presentation Type | Device | Presentation Type Score |
|---|---|---|
| Popup Alert | Any | 2000 |
| Alert Counter on App Icon | Phone | 1000 |
| Item in Notification List | Any | 1600 |
| Full Banner | Any | 1400 |
| Stub Banner | Any | 1200 |
| Alert Counter within App | Any | 600 |
| Toast | Phone | 900 |

In an exemplary embodiment, the weight of a received notification is determined as follows. The weight is initialized to the default notification weight specified for the notification category (by the developer or user, or otherwise as explained above). By comparing the notification weight to the presentation type scores of different presentation types, a notification presentation type is selected for the notification. For example, on a particular device, the presentation type may be selected as the presentation type with the presentation type score nearest to the notification weight. Alternatively, the presentation type may be selected as the presentation type with the lowest presentation type score that is greater than the notification weight. In another embodiment the presentation type may be selected as the presentation type with the highest presentation type score that is less than the notification weight.

In some embodiments, more than one presentation type may be used for particular notifications. For example, in some embodiments, the presentation types are selected as the presentation types the sum of whose presentation type score is at least as large the notification weight. For example, consider two notifications: a Customer Response Available notification and a Margin Call notification. In an exemplary embodiment, the Customer Response Available notification is presented using every notification type whose score is below 1000, and the Margin Call notification is presented using every notification type whose score is below 5000. The level of user engagement required to clear a notification may depend at least in part on the priority level of the notification. For the exemplary Customer Response Available notification, the priority level is 1, so the level of interaction needed to remove it from every place where it is shown is relatively low. For the exemplary Margin Call notification, the priority level is 4, so the level of interaction needed to remove it from every place where it is shown is relatively high.

In some embodiments, an order of presentation of the notification may be determined based on its relative priority with respect to other active notifications.

If the notification is not presented to a user, the weight of the notification does not change. However, the notification may be withdrawn or downgraded by the application, or an overriding condition may be met, in which case the notification is withdrawn.

If a notification is presented to a user, the weight of the notification may be changed. In some embodiments, the weight of the notification is reduced based on a level of engagement of the user with the notification. In an exemplary embodiment, the weight is reduced by a sum of a device focus score, an environmental factor score, and a device state score. There may be a predefined minimum (e.g., 100) and maximum (e.g., 250) for each of the scores. The scores may be summed per second (or other time interval) of presentation of the notification. At the end of the user's engagement with the notification, the notification is assigned an updated weight that reflects the user's level of engagement with the notification.

The updated weight of the notification is sent to the notification server, which in turn propagates the updated weight to other devices associated with the user. The update weight is used by the user's associated devices to determine how the notification is treated. In some embodiments, if a required level of user engagement has been met, the notification may be removed. (Some notifications, such as a notification of a margin call, may require a high level of user engagement, such as an explicit interaction, before the notification is removed.)

In some embodiments, the notification server operates to determine whether the updated notification weight is below a threshold weight. If the updated notification weight is below the threshold weight, the notification is treated as having been read and is dismissed across all devices. The threshold may be zero, or it may be a nonzero threshold.

In some embodiments, the level of user engagement with a notification depends not only on a user's explicit interactions with the notification but also on measured factors representing a user's likely level of attention to the notification. For example, a user who glances at a notification for three seconds in a quiet environment may be considered to have a higher level of engagement than a user who glances at a notification for three seconds in a noisy environment. Similarly, a user who interacts with a notification on a computer with several open windows may have a lower level of engagement than a user who interacts in the same way with the notification on a computer with a less cluttered desktop.

Different techniques are contemplated for preparing a measurement of a user's level of engagement with a notification. In one embodiment, the user's level of engagement with a notification is based on the device's focus score, which captures the typical level of the user's focus on information on the device. A device where the user has fewer likely distractions has a higher focus score. For example, ordinarily the rating would be highest for a desktop personal computer and successively lower for laptop, kiosk computer, tablet, phone, wristwatch, and augmented reality glasses. The notification manager could be preconfigured accordingly or supplied by each device vendor.

TABLE 3

| Device Type | Device's Focus Score |
|---|---|
| Desktop Computer | 100 |
| Laptop Computer | 90 |
| Kiosk Computer | 80 |
| Tablet | 70 |
| Phone | 50 |
| Wristwatch | 30 |
| Glasses | 5 |

In some embodiments, the estimation of a user's level of engagement with a notification is based at least in part on an environmental factor score. The environmental factor score may be based on one or more of a level of ambient noise and a level of crowdedness. Specifically, the level of engagement is considered lower in a setting that is noisier or more crowded.

The level of ambient noise may be measured using a microphone built in to the user device. Various techniques may be used to measure the level of crowdedness. In one such technique, a wireless transceiver in the user device counts the number of active Bluetooth devices in proximity to the user device, with the number of Bluetooth devices serving as a measure of the level of crowdedness. In another such technique, a camera in the user device obtains one or more video or still images of the environment, and the user device counts the number of people in the video or still image (e.g., using face recognition or other techniques)

Additional environmental factors can also have an effect on the environmental score, including crowd movement and flashing lights, such as may be detected through the user's wearable glasses or through cameras in the environment. In Table 4, below, the term “number of people” refers to a number of other people (not including the user) within the same room or within a distance of 20 ft (if in a hall) in the last 10 minutes, although other criteria of crowdedness may also be employed.

TABLE 4

| Environmental Factor and Value Range | Environmental Factor Score |
|---|---|
| Noise below 40 dB | 100 |
| Noise between 41 dB and 75 dB | 80 |
| Noise between 76 dB and 90 dB | 50 |
| Noise between 91 dB and 120 dB | 15 |
| Noise 121 dB and above | 5 |
| Number of People is 0 | 100 |
| Number of People is 1 to 3 | 70 |
| Number of People is 4 to 10 | 60 |
| Number of People is 11 or higher | 40 |

In some embodiments, the estimation of a user's level of engagement with a notification is based on the device state at the time of usage. For example, the level of engagement is considered lower in device states showing more ongoing activities. For example, if more windows are open on a desktop or laptop computer, or if more apps have been opened recently by the user on a phone, or if the user's wearable glasses shows multiple cards, the level of engagement is considered to be lower.

TABLE 5

| | Device State |
|---|---|
| Device State | Score |
| Computer windows open (not minimized) 2 or fewer | 100 |
| Computer windows open (not minimized) between 3 and 5 | 80 |
| Computer windows open (not minimized) 6 or more | 40 |
| Glasses show 2 or fewer cards | 80 |
| Glasses show between 3 and 5 cards | 60 |
| Glasses show 6 or more cards | 20 |

In one embodiment, the estimation of a user's level of engagement with a notification is based in part on the user's familiarity with various elements of the engagement, including the environment, the device, and the application. A user who more frequently experiences a crowded environment may be considered to have a higher environmental factor score in that environment than another user who experiences a crowded environment less frequently. A user who has logged a large number of interactions with a particular device (or similar device) may be considered to have a higher environmental factor score than a user who has logged fewer interactions with the device and thus may be less familiar with the device. Similarly, a user who has logged a large number of interactions with a particular application may be considered to have a higher environmental factor score than a user who has logged fewer interactions with the application and thus may be less familiar with the application.

In embodiments for use on an Android device, the Device Notification Manager can be modeled using the Android Notification Manager, which supports a way to cancel a notification on a device, which can be used to remove a notification. Analogous features can be used in the programming of other devices.

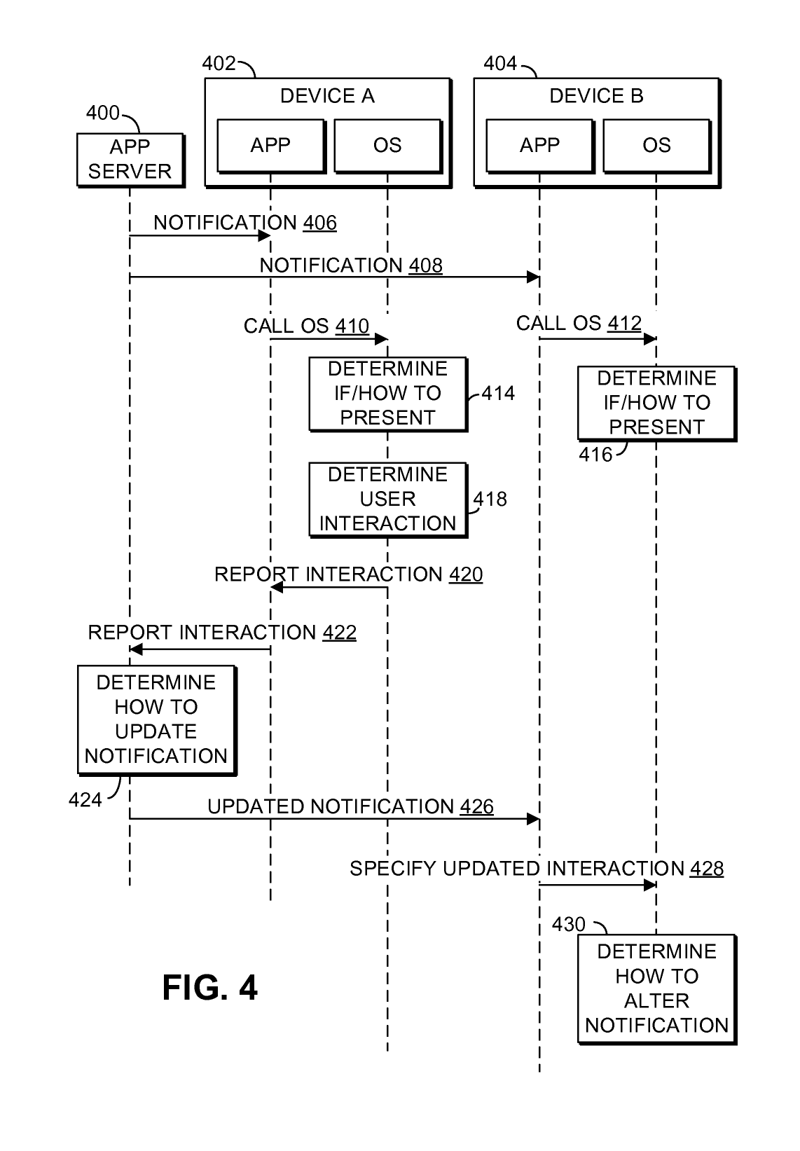

FIG. 4 is a message sequence chart illustrating an exemplary high-level architecture employed in some embodiments. This figure shows the main components and how they interact to execute the method. In messages 406 and 408, notification content is sent from a networked application server 400 to corresponding local applications on devices A (402) and B (404) associated with a user. In the example of FIG. 4, the networked application is a brokerage application, device A is a smartphone running the Android operating system, and device B is an iPhone running the iOS operating system. Devices A and B each run local brokerage applications.

In response to receiving the notification content, the local applications call the operating systems of the respective devices in steps 410, 412 to generate a notification, such as an alert, that is to be presented to the user. The respective operating systems determine whether and how to present the notification to the user in steps 414, 416.

In the example of FIG. 4, the user interacts with or otherwise engages with the notification on device A. In one embodiment, the operating system of device A determines the level of the user's engagement with the notification in step 418 and reports the extent of this engagement in step 420 to the associated user application on device A. The user application on device A in turn sends a report regarding the level of engagement to the application server in step 422. In an alternative embodiment, the operating system of device A reports the level of engagement directly to the application server.

Having received a report on the extent of the user's engagement with the notification, the application server determines in step 424 how to update the notification content according to the principles described in the present disclosure. Subsequently, the application server sends updated notification content in step 426 to device B. For example, the application server may instruct device B to downgrade the notification. In step 428, the local application on device B instructs the operating system of device B of the updated notification. For example, the local application on device B may instruct the operating system of device B to cancel the notification. In step 430, the operating systems determines how to alter the notification (e.g., by changing the notification style to a less prominent notification, or by canceling the notification).

In the example of FIG. 4, functions are illustrated as being allocated in a particular way between the operating systems and the applications of different user devices. It should be noted that other allocations of functions may be implemented and are contemplated within the scope of the present disclosure. For example, some or all of the functions of determining how to present a notification (steps 414, 416), determining a user interaction (step 418), and determining how to alter a notification (step 430) may be implemented by applications rather than operating systems of the respective devices.

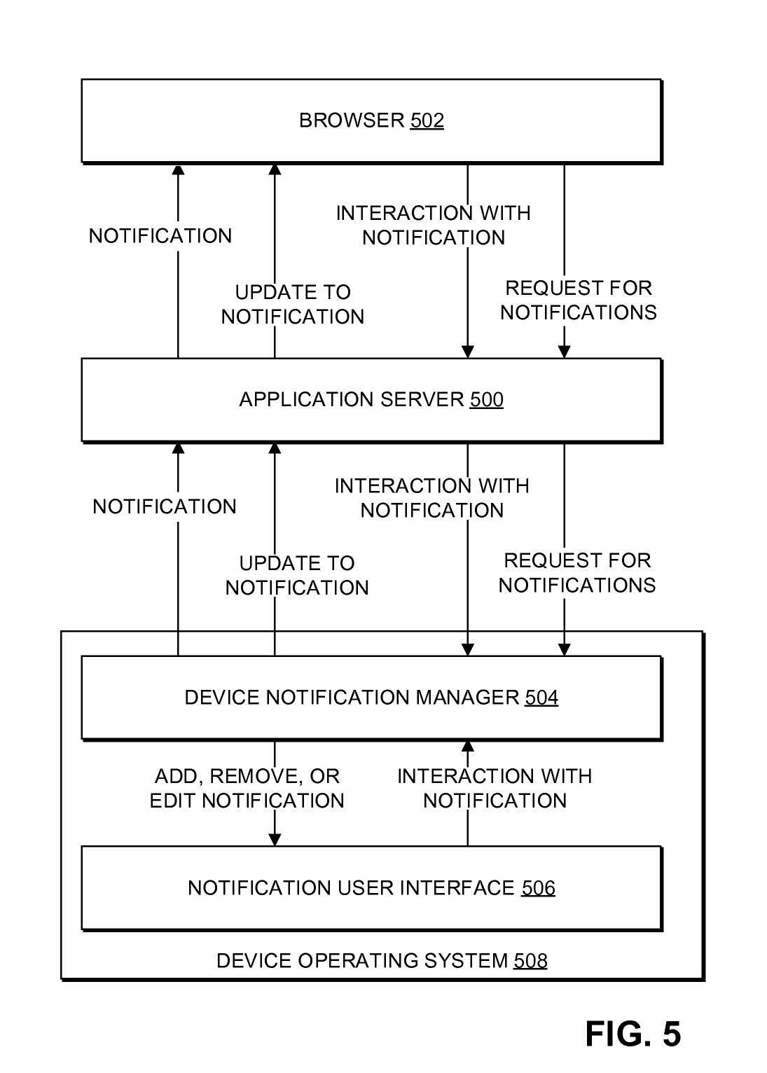

As illustrated in FIG. 5, in some embodiments, an application server 500 is provided. The application server 500 includes application logic, a server notification manager, a subscription module, a decision module, and a notification store. The application server is provided with a network interface through which a user can configure user-specific information through a Web browser 502 or through an application. Through the network interface, the application server can display and update notifications on a user's browser. The browser conveys user actions, such as configuration information, to the application server. A pull-based browser can request notifications and updates to notifications from the application server.

A device notification manager 504 runs on a device where a downloaded application associated with the application server is running. The application server sends notifications and updates to notifications to the device notification manager 504. In pull-based embodiments, the device notification manager 504 requests notifications and updates from notifications from the application server 500.

The device notification manager 504 controls the notification user interface 506 and determines what notifications are presented on it, and how they are presented. The device notification manager 504 reports levels of user engagement with the notifications to the application server that it receives from the notification user interface.

The notification user interface 506 presents notifications to the user and accepts user actions on the notifications. The device notification manager 504 and the notification user interface 506 may be features of the operating system 508 of the relevant user device.

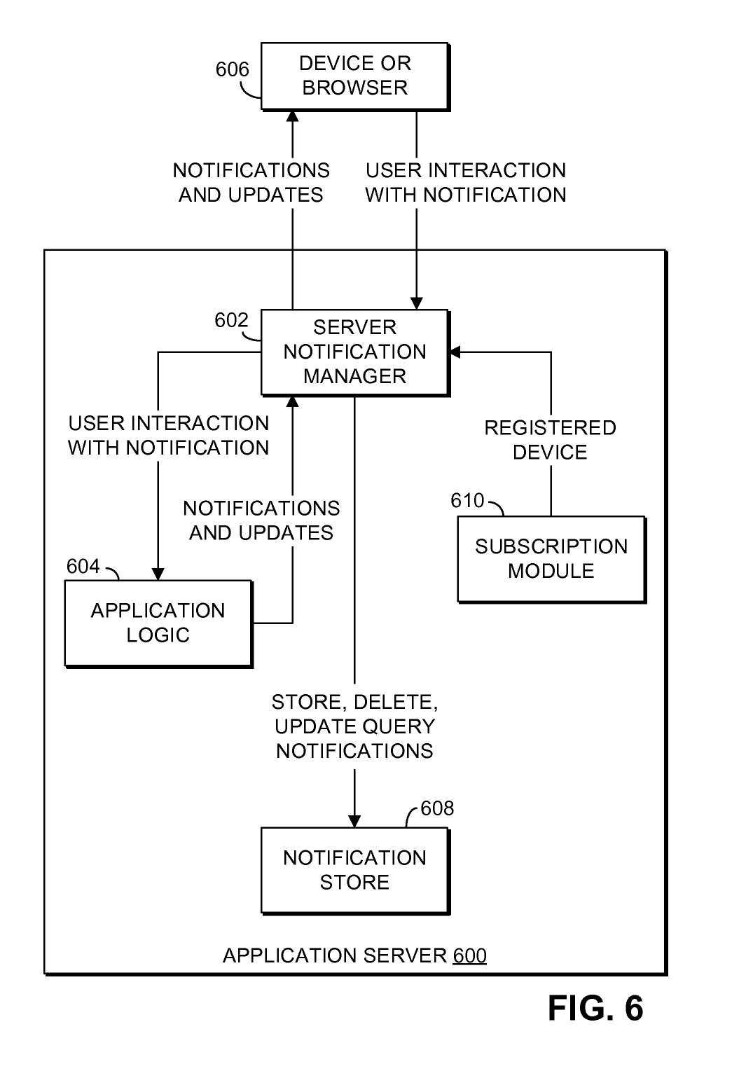

An exemplary architecture of an application server 600 is illustrated in FIG. 6. A server notification manager 602 is provided to accept notifications from the application logic 604. The server notification manager 602 also interacts with the device notification manager or browser 606 as described above.

A notification store 608 keeps track of the notifications that have been sent out that are still active. The notification store also keeps track of the state of each active notification, for example by storing the notification weight of each notification.

A subscription module 610 keeps track of which devices the notification manager should communicate with. The subscriptions may be updated and managed through known techniques.

The application logic 604 determines what notifications to send to a user. The application logic also determines whether to update (including revoke) a notification. For example, if the user has dismissed a notification, the application logic may request that the notification be revoked on every device and browser and removed from the notification store. If the user has engaged with (e.g., viewed) a notification but not dismissed it, the application logic 604 may lower the notification weight of the notification. Some types of notification may be sufficiently significant that the notification weight is not lowered unless the users explicitly dismissed the notification.

In some embodiments, the application logic 604 determines whether a notification has expired or otherwise become irrelevant because of a subsequent notification. For example, a notification that one person commented on a posting by the user can be removed in light of a new notification that two persons have commented on the same posting by the user. In other words, the first notification is no longer informative. The decision of whether a notification is redundant depends on what user experience the application designer wishes to offer a user or what preferences the user has with regard to notifications.

The application logic 604 makes use of a set of hooks by which the application logic can generate and update notifications and through which user actions can be conveyed to the application logic. These hooks include a way for the application logic to identify notifications and updates and to store and share information about those notifications and updates. Specifically, the application logic may specify the priority, overriding condition, and acceptable levels of user engagement upon which the notification can be revoked. Table 1 illustrates an example of notification categories that may be assigned with respect to alerts pertaining to a brokerage application.

TABLE 1

| | | | Acceptable User |
|---|---|---|---|
| | Priority | Overriding Condition | Engagement |
| Customer | 1 | A new customer response | Glance |
| response | | notification is generated | |
| available | | | |
| Order | 1 | When a notification for the | Partial view by user |
| received | | same order expiring or | |
| | | executing is created | |
| Order | 2 | When a notification of | Full view by user |
| expired | | another order expiring is | |
| | | generated | |
| Order | 3 | When a notification of | Expanded by user |
| executed | | another order being executed | |
| | | is created | |
| Margin | 4 | None | Explicit confirmation of |
| call | | | receipt by user |

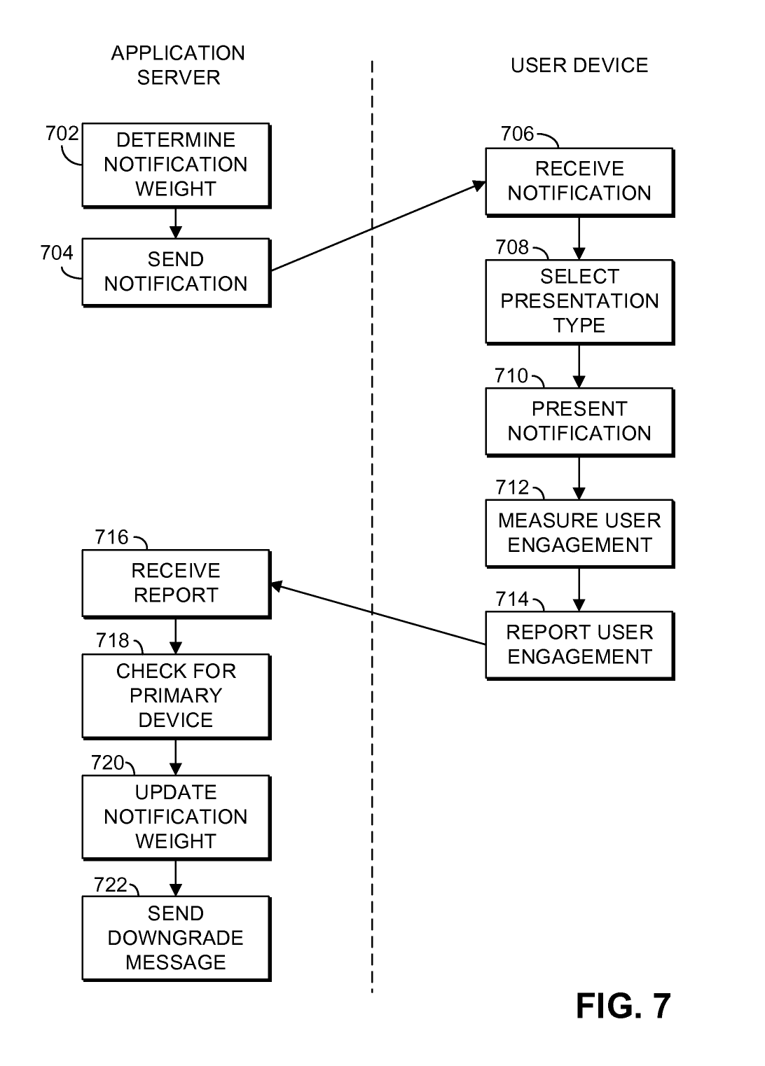

An exemplary method of updating notifications is illustrated in FIG. 7. In step 702, an application server determines an initial notification weight of a notification to be sent to a user. The initial notification weight may be a default notification weight based on the type of notification. In step 704, the notification is sent to the user devices associated with the user. A list of user devices associated with the user, and the relevant addresses of those devices may be stored in a database by the subscription module (610, FIG. 6).

In step 706, one of the user devices receives the notification. Based on the notification weight, which may be sent with the notification, the user device selects a notification presentation type. For example, the user device may store a record of available presentation types together with associated presentation type scores (see Table 2, above). The mobile device then selects a presentation type with a presentation type score appropriate for the notification weight (e.g. a presentation type score closest to the notification weight, among other possibilities).

In step 710, the user device presents the notification to the user using the selected notification presentation type. In step 712, the user device measures a level of user engagement with the notification. This level may be based at least in part on an amount of time the notification is visible to the user, the amount of time the user gazes at the notification, a level of active interaction with the notification (e g, minimizing or dismissing the notification), or through other techniques. The measured level of user engagement with the notification may depend in part on a device focus score representative of the ability of the device to capture the user's attention. The device focus score may be predetermined for each particular device or type of device of a user (see Table 3).

In some embodiments, the measured level of user engagement with the notification depends in part on an environmental factor score representative of how conducive the user's physical environment is to absorption of information from the device. For example, the environmental factor score may be based at least in part on a level of ambient noise, with a high level of ambient noise resulting in a lower environmental factor score. In some embodiments, the environmental factor score may be based at least in part on a level of crowdedness, with a crowded environment resulting in a lower environmental factor score.

In some embodiments, the measured level of user engagement with the notification depends in part on a device state score representative of how conducive the state of the user device is to absorption of information from the device. For example, the device state score may be based at least in part on number of windows that are open and not minimized on the user device.

In step 714, the user device reports the level of user engagement to the server. In some embodiments, the report indicating the level of user engagement includes an updated notification weight of the notification. In such an embodiment, the user device calculates the updated notification weight from the initial notification weight and the level of user engagement with the notification, for example by subtracting the device focus score, environmental factor score, and device state score from the initial notification weight. In other embodiments, the user device reports the level of engagement to the server, and any updating of the notification weight, if necessary, may be performed by the server. In some embodiments, instead of a numeric level of engagement, the report of the level of user engagement is a report of a type of user engagement, e.g. a report indicating that the user has dismissed, minimized, or otherwise interacted with the notification.

In step 716, the application server receives the report regarding user engagement with the notification. In some embodiments, the server determines in step 718 whether the device with which the user interacted is a predetermined primary device. An identification of a user selected primary device may be stored in a database accessed by the application server. The selection of the primary device may be made by a user. The selection of a primary device allows users to ensure that certain important notifications are not dismissed until the user has had an opportunity to handle the notification on a selected device. For example, the user may want to ensure that notification of a margin call is not dismissed until that notification has been dealt with on a personal computer, rather than on a smartphone. If the user device with which the user interacted is not a primary device, the application server may take no further steps to dismiss or otherwise downgrade the notification on other devices associated with the user.

In some embodiments, the application server operates in step 720 to update the notification weight of the notification. If an updated notification weight has been received from the user device, step 720 may simply include storing the updated notification weight in the notification store (608). In other embodiments, the application server 720 calculates an updated notification weight based on the report received in step 716. For example, where the report received in step 716 includes a numeric level of engagement with the notification, the application server may subtract the level of engagement from the initial notification weight to obtain the updated notification weight.

In step 722, the application server sends a message downgrading the notification to the devices associated with the user. A notification identifier may be used (e.g. sent in steps 704 and 722) to allow user devices to associate an update with a particular notification. In some embodiments, the message downgrading the notification is a message providing the updated notification weight to the user devices. Each of the user devices may then change the presentation type of the notification based on the new notification weight.

In some embodiments, the downgrade message is a message dismissing the notification. For example, the application server may operate to determine whether the updated notification weight is below a threshold weight and may send a message dismissing the notification in step 722 if the notification weight is below a threshold. The threshold may be zero, for example, or it may be a nonzero threshold.

In some embodiments, the functions of the application server are be performed by a system that includes a processor and a nontransitory computer-readable storage medium, where the storage medium stores instructions that are operative, when executed on the processor to perform the functions described herein. For example, the system is provided with instructions to send a notification to a plurality of user devices associated with a user, including at least a first user device and a second user device. Further instructions are provided to enable the system to receive a report from the first user device including an indication that the user has engaged with the notification. In response to the report from the first user device, instructions direct the system to send a message to at least the second user device downgrading the notification.

In an exemplary method, a notification is sent to a plurality of user devices associated with a user, including at least a first user device and a second user device. A report is received from the first user device indicating that the user has interacted with the notification. In response to the report from the first device, a message is sent at least to the second device downgrading the notification.

In such an embodiment, the notification may be, for example, a notification from a social networking service indicating that a message has been received, a notification that a friend of the user has posted a comment, a notification from a social networking site informing the user that there is a new friend request, or a notification that a securities transaction has been executed, or a notification from a banking site indicating that a message is waiting from the bank.

In some embodiments, the message downgrading the notification is a message revoking the notification. The message downgrading the notification is sent in some embodiments to all devices associated with the user.

In some embodiments, the report indicating that the user has interacted with the notification may include a report that the user has dismissed the notification or that the user has cleared a notification list. In some embodiments, the notification is a modal dialog, and the report includes a report that the user has interacted with the modal dialog. In some embodiments in which the first user device is electronic glasses, the report from the user device includes an indication that the user has fixated on an icon representing the notification. In some embodiments where the first user device is a wearable computer, the report from the user device includes an indication that the user has viewed the notification on the wearable computer. In some embodiments, the report indicating that the user has interacted with the notification includes information regarding the level of engagement with the notification, such as a report regarding the amount of time that the user viewed the notification. In some embodiments, the report indicating that the user has interacted with the notification includes a report indicating that the user has expanded the alert to see its content.

In some embodiments, where the notification is held in a notification store, the notification is removed from the notification store in response to the report from the first user device.

Some embodiments include a step of determining whether the first user device is a predetermined primary device. In such embodiments, the sending of the message downgrading the notification is performed only after determining that the first user device is a predetermined primary device. In some embodiments, the method includes determining whether the second user device is a predetermined primary device; where the message downgrading the notification is sent to the second user device only after determining that the second user device is not a predetermined primary device.

Some embodiments include a step of determining a category of the notification, where the message downgrading the notification is sent only after determining that the category of the notification is a category subject to downgrading. Some embodiments include determining a level of importance of the notification, where the message downgrading the notification is sent only after determining that the importance of the notification is below a predetermined threshold of importance.

In exemplary embodiments, the report of the level of engagement includes a report that the user has glanced at the notification, a report that the user has partially viewed the notification, a report that the user has fully viewed the notification, a report that the user has expanded the notification, a report that the user has confirmed receipt of the notification, and/or a report that the user has dismissed the notification.

Some embodiments further include the steps of determining an acceptable level of user engagement with the notification, determining whether the report indicates that the user has met the acceptable level of engagement with the notification, and sending the message downgrading the notification only after determining that the report indicates that the user has met the acceptable level of engagement with the notification.

Some embodiments further include the steps of determining an overriding condition for the notification, determining an acceptable level of user engagement with the notification, determining whether the report indicates that the user has met the acceptable level of engagement with the notification, determining whether the overriding condition for the notification has occurred, and sending the message downgrading the notification only after determining that the report indicates that the user has met the acceptable level of engagement with the notification or after determining that the overriding condition for the notification has occurred.

In an exemplary embodiment, a user device receives a notification from an application server and presents the notification to a user of the device. The user device detects a level of engagement between the user and the notification and sends a report of the level of engagement to the application server.

In some such embodiments, the user device is a smartphone, and the presenting of the notification includes displaying the notification in a banner on a screen of the smartphone. In some embodiments, the user device is electronic glasses, and presenting of the notification includes displaying the notification in a readout of the electronic glasses.

In some embodiments, the report on the level of engagement includes a report that the user has dismissed the notification, a report that the user has cleared a notification list, and/or a report that the user has interacted with a modal dialog.

In an exemplary embodiment, a method is provided of sending a notification to a plurality of local applications associated with a user, including at least a first local application and a second local application. A report is received from the first local application indicating that the user has interacted with the notification. In response to the report from the first local application, a message is sent to at least the second local application downgrading the notification. The first and second local applications may be on the same user device or on different user devices. In some embodiments, the message downgrading the notification may be a message canceling the notification.

In an exemplary embodiment, an application server is provided with application logic and a server notification manager. The application logic is operative to generate a notification. The server notification manager is operative to send the notification to a plurality of user devices associated with a user, including at least a first user device and a second user device. The server notification manager is further operative to receive a report from the first user device indicating that the user has interacted with the notification. The application logic is further operative, in response to the report from the first device, to send a message to at least the second user device downgrading the notification. In some such embodiments, the application server further includes a notification store operative to track the state of each active notification.

In another exemplary embodiment, a system includes a processor, a network interface, a user interface, and a non-transitory computer-readable storage medium storing instructions. The instructions are operable, when executed on the processor, to receive a notification from an application server over the network interface. The instructions are further operative to present the notification to the user over the user interface in a first format and to detect a level of interaction between the user and the notification. The instructions are further operative to send to the application server, over the network interface, a report of the level of interaction between the user and the notification. In some such embodiments, the level of interaction is selected from the group consisting of glancing at the notification, partial viewing of the notification, full viewing of the notification, expanding of the notification, and explicit confirmation of receipt by a user.

In some such embodiments, the instructions are further operative to receive a message from the application server downgrading the notification and, in response to the message downgrading the notification, to present the notification to the user over the user interface in a second format.

In some embodiments, the instructions are further operative to receive a message from the application server downgrading the notification and, in response to the message downgrading the notification, to cancel the notification.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer

1-20. (canceled)

21. A method comprising:
sending a notification to a plurality of user devices associated with a user, including at least a first user device and a second user device, wherein the notification includes an initial notification weight;
receiving a report from the first user device including an indication that the user has engaged with the notification, wherein the indication that the user has engaged with the notification includes a measured level of engagement;
determining an updated notification weight from the initial notification weight and the measured level of engagement; and
in response to the report from the first user device, sending a message to at least the second user device downgrading the notification, wherein the message downgrading the notification includes the updated notification weight.

22. The method of claim 21, further comprising:
determining whether the updated notification weight is below a threshold weight;
wherein, in response to a determination that the updated notification weight is below the threshold weight, the message downgrading the notification is a message dismissing the notification.

23. The method of claim 21, further comprising determining whether the first user device is a predetermined primary device, wherein the sending of the message downgrading the notification is performed only after determining that the first user device is a predetermined primary device.

24. The method of claim 23, wherein the primary device is selected through user configuration.

25. A method comprising:
receiving from a server a notification having an initial notification weight;
selecting a notification presentation type based on the initial notification weight;
presenting the notification to a user using the selected notification presentation type;
measuring a level of user engagement with the notification; and
providing to the server an indication of the level of user engagement.

26. The method of claim 25, further comprising calculating an updated notification weight from the initial notification weight and the level of user engagement with the notification;
wherein providing an indication of the level of user engagement includes providing the updated notification weight to the server.

27. The method of claim 25, wherein providing an indication of the level of user engagement includes providing the measured level of user engagement to the server.

28. The method of claim 25, wherein the level of user engagement with the notification depends in part on a device focus score.

29. The method of claim 25, wherein the level of user engagement with the notification depends in part on an environmental factor score.

30. The method of claim 29, wherein the environmental factor score is based at least in part on a level of ambient noise.

31. The method of claim 25, wherein the level of user engagement with the notification depends in part on a device state score.

32. The method of claim 31, wherein the device state score is based at least in part on number of open windows.

33. A system including a processor and a nontransitory computer-readable storage medium, the storage medium storing instructions that are operative, when executed on the processor:
to send a notification to a plurality of user devices associated with a user, including at least a first user device and a second user device;
to receive a report from the first user device including an indication that the user has engaged with the notification; and
in response to the report from the first user device, to send a message to at least the second user device downgrading the notification;
wherein:
the notification includes an initial notification weight; and
the indication that the user has engaged with the notification includes an updated notification weight lower than the initial notification weight.

34. The system of claim 33, wherein the instructions are further operative to determine whether the first user device is a predetermined primary device, wherein the instructions are operative to send the message downgrading the notification is performed only after determining that the first user device is a predetermined primary device.
